(19) United States
(12) Patent Application Publication
(10) Pub. No.: US 2011/0161364 A1
(43) Pub. Date: Jun. 30, 2011

(54) SYSTEM AND METHOD FOR PROVIDING A NORMAL FILE DATABASE

(75) Inventor: Kyu Beom Hwang, Gyeonggi-do (KR)

(73) Assignee: AHNLAB, INC., Seoul (KR)

(21) Appl. No.: 13/060,820

(22) PCT Filed: Aug. 27, 2009
(86) PCT No.: PCT/KR2009/004788

§ 371 Date: Feb. 25, 2011

(30) Foreign Application Priority Data
Aug. 29, 2008 (KR) 1020080085106

(51) Int. Cl. G06F 17/30

(52) U.S. Cl. 707/769; 707/E17.108

(57) ABSTRACT

The present invention relates to a system for providing a normal file database, including a database server in which a normal file database constructed for different operating systems is stored, and a file providing server for searching a normal file database corresponding to operating system information on the basis of the operating system information of a terminal installed with an antivirus program through the database server, and providing the searched normal file database to a terminal through a communication network. As described above, the present invention creates a normal file database in a state where no intrusion by external sources such as viruses or malicious code has occurred, and provides the created database to a terminal through a communication network, thus improving the reliability of the normal file database.

### TECHNICAL FIELD

The present invention relates to a normal file database used in an anti-virus program, and more particularly, to a system and method for providing a normal file database, which has been made in a state being free from an external intrusion such as a virus or a malicious code, to a terminal through a communication network.

### BACKGROUND ART

In general, an anti-virus program is designed to configure a database storing information regarding normal files in a terminal in order to improve the speed for a virus and malicious code diagnosis.

In configuring the database, a method of filtering the normal file includes recognizing basic information of a file on a file system within the terminal to check whether or not the file has been changed, and if it is checked that the file has been changed, and recognizing important contents of the file to verify the changed file based on the actually changed contents.

Meanwhile, when the anti-virus program detects the presence of a virus or a malicious code only with the basic information in the file system, if a file is corrected without contents added thereto, e.g., in case of a code patch or a virus infection, the anti-virus program may fail to properly detect the malicious code.

Thus, in order to solve the above problem, a monitoring module of the anti-virus program determines whether or not the file has been corrected by using a method of monitoring writing with respect to the corresponding file and a method of verifying a padding area in the header.

As such, the anti-virus program monitors files existing in the database storing normal file-related information, but skips or excludes the monitoring with respect to files not present in the database. In this regard, the file-related information includes values representing respective files, such as a message digest value (a value such as CRC64, or the like) of the entire path where the files exist, a file creation time, a message digest value obtained by contracting an important part of file contents, a message digest value for a padding area of a file, and a message digest value for the overall contents of a file.

That is, the anti-virus program checks whether or not a file in the terminal has been changed on a basis of the file-related information stored in the database, and then diagnoses a virus and a malicious code depending on the check results to cure the file. More specifically, the anti-virus program compares the file-related information stored in the terminal with the file-related information stored in the database, and when they are the same, the anti-virus program skips checking, whereas when they are not the same, indicating that a file has been changed, the anti-virus program checks the file to determine whether or not it has been infected by a virus or a malicious code to perform a cure of the file.

The method of comparing the file-related information may include, for example, a method of calculating a hash value of the file.

Such a database is reset at a period when an engine code or data of the anti-virus program is updated and reconfigured by using file-related information in the terminal at the engine update. As described above, in configuring the database, basic information of a file system in a terminal is recognized to check whether or not a file has been changed, and if it is checked that the file has been changed, important contents of the file are caught to verify the changed file based on the actually changed particulars, thus filtering the normal file.

However, because a normal file database used for diagnosing a virus or a malicious code is installed in the terminal by the anti-virus program, in a case where a new sample or a sample of the virus or the malicious code which has been previously exist in the terminal but not diagnosed before configuring the file database, a malicious file having such a sample may be regarded as a normal file.

In addition, because the normal file database is reset and reconfigured depending on the engine updating period, a file infected by a new malicious code or a malicious code, which has not been diagnosed before the engine updating may be regarded as a normal file, and thus the anti-virus program may recognize such an infected file as a normal file.

Moreover, in recent, as the engine updating period is shortened, the database is frequently reset accordingly, degrading efficiency.

### DISCLOSURE

### Technical Problem

It is, therefore, an object of the present invention to provide a system and method for providing a normal file database, which has been made by a normal file server operated in a company such as a vaccine company in a state not being exposed, to an external intrusion such as a virus or malicious code, to a terminal through a communication network.

### Technical Solution

In accordance with the present invention, there is provided a system for providing a normal file database, the method including: a database server for storing normal file databases configured for different operating systems; and a file server for searching the database server for a normal file database corresponding to information regarding an operating system of a terminal in which an anti-virus program is installed on a basis of the information, and providing the searched normal file database to the terminal through a communication network.

In accordance with the present invention, there is provided a method for providing a normal file database using a database server having normal file databases configured for different operating systems, the method including: recognizing information regarding operating systems of multiple terminals in which an anti-virus program is installed; searching for a normal file database suitable for a terminal in which the same operating system as the recognized operating system is installed based on the recognized information regarding the operating systems; and providing each of the searched normal file databases to each of the terminals through a communication network.

Accordingly, a normal file database is created in a state not being infected by a virus or a malicious code, and is provided to a terminal through the communication network, thereby improving the reliability of the normal file database.

In addition, the normal file database is configured for each different operating system and is then provided to a terminal. Therefore, the terminal needs not configure the normal file database, which reduces the load in the terminal.

### BRIEF DESCRIPTION OF THE DRAWINGS

FIG. 1 schematically shows a block diagram of a system for providing a normal file database in accordance with an embodiment of the present invention; and

FIG. 2 is a flowchart illustrating a method for providing a normal file database in accordance with an embodiment of the present invention.

### BEST MODE FOR THE INVENTION

Hereinafter, an embodiment of the present invention will be described in detail with the accompanying drawings. In the following description, well-known constitutions or functions will not be described, in detail if they would obscure the invention in unnecessary detail.

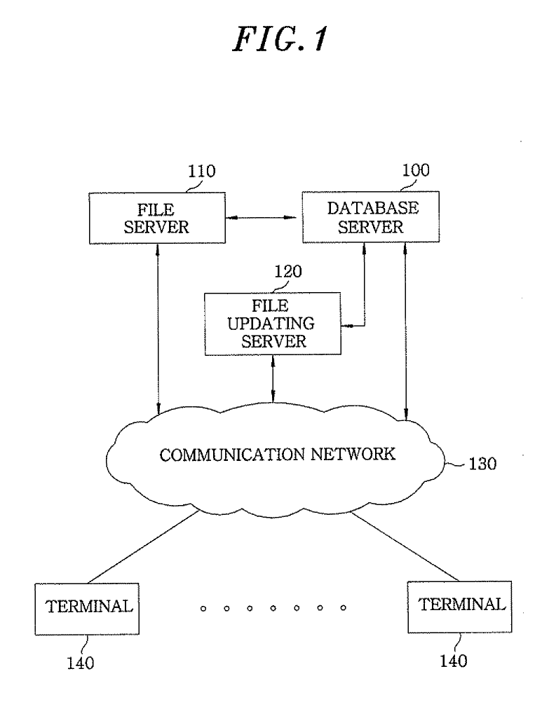

FIG. 1 schematically shows a block diagram of a system for providing a normal file database in accordance with an embodiment of the present invention. As shown therein, the system includes a database server 100, a normal file server 110, a file updating server 120, a communication network 130, and multiple terminals 140.

The terminals 140 have an anti-virus program installed therein. A normal file database required for driving the anti-virus program is installed in the respective terminals 140.

The database server 100 stores normal file databases for different operating systems, e.g., Windows 98, Windows 2000, Windows XP, Vista, Linux, and the like, and searches for a normal file database and provides the same to the file server 110 in response to a request from the file server 110.

Also, the database server 100 receives software patch information regarding each of the operating systems through the communication network 130 and updates the normal file database of a certain operating system based on the received software patch information regarding each of the operating systems.

As used herein, the normal file database is configured by using file-related information stored in a storage medium, e.g., a hard disk or an optical disk, in which an operating system is installed at a state being free from a virus or a malicious code. More specifically, the normal file database is configured by using file-related information stored in a storage medium in which basic utility programs, e.g., Word editor, Hangul editor, a decompression program, a media reproducing program, and the like, as well as the operating systems, are installed.

The file server 110 serves to distribute the normal file databases to the terminals 140 through the communication network 130. In this case, the file server 110 receives information regarding an operating system installed in each of the terminals 140, receives a normal file database corresponding to the information regarding the operating system from the database server 100 based on the received information, and provides the received normal file database to each of the terminals 140.

The file server 110 may be implemented by using a server providing an updating engine of the anti-virus program. In this case, the file server may recognize the information regarding the operating system of each of the terminals 140 when the updating engine is distributed, and distribute the normal file database to each of the terminals 140 on the basis of the recognized information.

When the normal file database associated with a certain operating system in the database server 100 is updated, the file updating server 120 provides the updated normal file database to the terminal 140 in which the same operating system as the certain operating system is installed. In particular, when the updating engine of the anti-virus program is distributed, the file updating server 120 provides the updated normal file database to the terminal 140 in which the certain operating system is installed, through the communication network 130.

The anti-virus program installed in the terminal 140 recognizes normal files not infected by a virus and a malicious code by using the normal file database received from the file server 110 through the communication network 130 so that diagnosing of an unnecessary virus and malicious code can be skipped.

Here, the terminal 140 may update the normal file database by comparing the received normal file database with file-related information stored in its storage medium. Namely, the terminal 140 may reconfigure the normal file database by extracting only relevant information of a file stored in the storage medium of the terminal 140 from the file-related information stored in the normal file database.

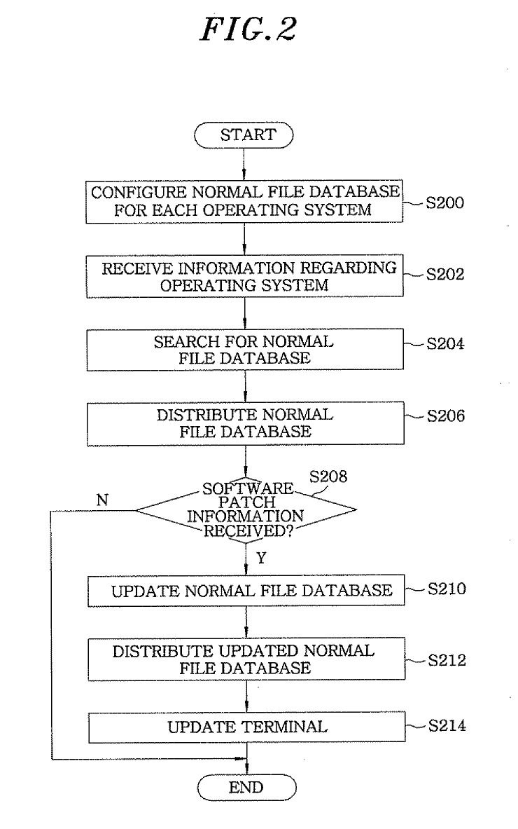

An operation process of the normal file database providing system configured as described above will now be described with reference to FIG. 2.

FIG. 2 is a flowchart illustrating a method for providing a normal file database in accordance with an embodiment of the present invention.

Referring to FIG. 2, in step S200, the database server 100 configures a normal file database for each operating system by using relevant information of files stored in a storage medium in which different operating systems and basic utility programs are installed.

Next, the file server 110 receives from the terminal 140 information regarding an operating system of the terminal 140 in which an anti-virus program is installed in step S202, and receives a normal file database corresponding to the information regarding the operating system which has been searched from the normal file database by the database server 100 in step S204.

And then, in step S206, the file server 110 distributes the normal file database received from the database server 100 to the terminals 140.

In an embodiment of the present invention, it has been described by way of example that the information regarding the operating system is received from the terminal 140 and the normal file database corresponding to the received information is distributed. Alternatively, the present invention may be configured such that the file server 110 recognizes the operating system installed in the terminal 140 in which the anti-virus program is installed, and then distributes a corresponding normal file database.

Meanwhile, the file server 110 may distribute the normal file database when distributing an updating engine of the anti-virus program installed in the terminal 140.

Thereafter, in step S208, the database server 110 determines whether or not software patch information regarding each operating system is received through the communication network 130.

As a result of the determination in step S208, if it is determined that software patch information regarding a certain operating system is received, in step S210, the database server 110 updates the normal file database corresponding to the certain operating system based on the patch information.

Subsequently, the file updating server 120 distributes the updated normal file database to the terminal 140 through the communication network 130 in step 212, and the normal file database of the terminal 140 driven by the certain operating system is updated in step S214.

The normal file database of the terminal 140 may be updated at the distribution of the updating engine of the anti-virus program installed in the terminal 140.

In accordance with the embodiment of the present invention, the terminal 140 itself does not configure the normal file database, but generates it in a safety operational environment, namely, in a state in which it is not infected by a virus or a malicious code, and then provides the same to the terminal 140 through the communication network 130, thereby improving the reliability of the normal file database.

While the invention has been shown and described with respect to the particular embodiments, it will be understood by those skilled in the art that various changes and modification may be made. Such a modified embodiment should be interpreted as being included in the scope of the following claims of the present invention.

1. A system for providing a normal file database, the system comprising:
a database server for storing normal file databases configured for different operating systems; and
a file server for searching the database server for a normal file database corresponding to information regarding an operating system of a terminal in which an anti-virus program is installed on a basis of the information, and providing the searched normal file database to the terminal through a communication network.

2. The system of claim 1, wherein the file server provides the normal file database to the terminal when an engine of the anti-virus program is updated.

3. The system of claim 1, wherein whenever a software patch of each operating system is provided, the database server updates the normal file database of the operating system based on information corresponding to the software patch.

4. The system of claim 3, further comprising:
a file updating server for providing an updated normal file database to the terminal in which a corresponding operating system is installed as the normal file database of said each operating system is updated.

5. The system of claim 4, wherein when the engine of the anti-virus program is updated, the file updating server provides the updated normal file database to the terminal.

6. A method for providing a normal file database using a database server having normal file databases configured for different operating systems, the method comprising:
recognizing information regarding operating systems of multiple terminals in which an anti-virus program is installed;
searching for a normal file database suitable for a terminal in which the same operating system as the recognized operating system is installed based on the recognized information regarding the operating systems; and
providing each of the searched normal file databases to each of the terminals through a communication network.

7. The method of claim 6, wherein said providing each of the searched normal file databases includes providing each of the searched normal file databases to each of the terminals at the distribution of an updated engine of the anti-virus program.

8. The method of claim 6, further comprising:
determining whether or not there is software patch information regarding a certain operating system;
if it is determined that there is the software patch information regarding the certain operating system, updating a normal file database corresponding to the certain operating system through the database server.

9. The method of claim 8, further comprising:
providing the updated normal file database to the terminal in which the certain operating system is installed as the normal file database is updated.

10. The method of claim 9, wherein said providing the updated normal file database includes providing the updated normal file database to the terminal when the anti-virus program installed in each of the terminals is updated.
